(19) United States
(12) Patent Application Publication
(10) Pub. No.: US 2015/0257104 A1
(43) Pub. Date: Sep. 10, 2015

(54) METHOD FOR CONTROLLING BEACON SIGNAL OF ELECTRONIC DEVICE AND ELECTRONIC DEVICE THEREOF

(71) Applicant: Samsung Electronics Co., Ltd., Suwon-si (KR)

(72) Inventors: Won-Suk CHOI, Seoul (KR); Kwang-Sub SON, Suwon-si (KR); Sung-Ho SON, Daegu (KR); Young-Eun HAN, Seongnam-si (KR)

(21) Appl. No.: 14/642,997

(22) Filed: Mar. 10, 2015

(30) Foreign Application Priority Data
Mar. 10, 2014 (KR) 10-2014-0027797

(51) Int. Cl. H04W 52/02; H04W 4/00

(52) U.S. Cl. CPC H04W 52/0229; H04W 4/008

(57) ABSTRACT

A method for operating an electronic device and an electronic device thereof are provided. The method for operating the electronic device includes receiving sensor information of the electronic device. Further, the method includes controlling, by the electronic device a beacon signal based on the sensor information.

### CROSS-REFERENCE TO RELATED APPLICATION(S)

This application claims the benefit under 35 U.S.C. §119(a) of a Korean patent application filed on Mar. 10, 2014 in the Korean Intellectual Property Office and assigned Serial number 10-2014-0027797, the entire disclosure of which is hereby incorporated by reference.

### TECHNICAL FIELD

The present disclosure relates to a method for controlling a beacon signal of an electronic device and an electronic device thereof.

### BACKGROUND

As a communication technology that will replace Near Field Communication (NFC), which is a short distance wireless communication, a Bluetooth Low Energy (BLE) beacon that utilizes BLE has been suggested. The BLE beacon not only provides position information but is also commercialized in various fields such as marketing, purchase, automatic check-in, etc.

A valid communication distance of NFC is limited to about 4 cm to 20 cm, but a valid communication distance of the BLE beacon extends to about 5 cm to 50 m. For NFC, each mobile communication terminal should install a separate chip. In contrast, since the BLE beacon enables short distance wireless communication that utilizes a beacon when only a BLE recognition function is provided, the BLE beacon is more economical than NFC and may provide a wireless communication service even in a wide indoor space.

From Bluetooth 4.0, which is a recent version of Bluetooth communication, synchronization with an unlimited number of mobile communication terminals is possible. The mobile communication terminals may be various types of electronic devices such as a smartphone or a tablet PC, etc. When a beacon application is executed or a user selects a specific icon provided by the beacon application program, the mobile communication terminal transmits/receives a beacon signal, and transmits contents determined in advance using a beacon signal of a predetermined period determined in advance.

To transmit/receive a beacon signal, a user of a terminal must typically execute a beacon application through various selection steps, or select a specific icon, and when the beacon application operates as a foreground program, the application continues to transmit a beacon signal in a predetermined period in spite of a circumstance where transmission of a beacon signal is unnecessary, so that battery power is consumed unnecessarily.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below.

Accordingly, an aspect of the present disclosure is to provide a method for controlling a beacon signal of an electronic device and an electronic device thereof, for dynamically controlling a transmission/reception operation of a beacon signal based on various sensor information in an electronic device such as a smartphone or a tablet PC, etc.

In accordance with an aspect of the present disclosure, a method for operating an electronic device is provided. The method includes receiving sensor information of the electronic device, and controlling, by the electronic device, a beacon signal based on the sensor information.

In accordance with another aspect of the present disclosure, an electronic device is provided. The electronic device includes a sensor module configured to detect sensor information, and a processor configured to control a beacon signal based on the sensor information detected by the sensor module.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a network environment including an electronic device according to an embodiment of the present disclosure;

FIG. 2 is a block diagram illustrating an electronic device according to an embodiment of the present disclosure;

FIG. 3 is a view illustrating a portion of an electronic device to which an embodiment of the present disclosure is applied;

FIG. 4 is a view illustrating a construction of a Bluetooth Low Energy (BLE) beacon packet according to an embodiment of the present disclosure;

FIG. 5 is a view illustrating a transmission process of a beacon signal according to an embodiment of the present disclosure;

FIG. 6 is a view illustrating a construction of a set advertisement parameter according to an embodiment of the present disclosure;

FIG. 7 is a view illustrating a construction of a set advertisement parameter according to an embodiment of the present disclosure;

FIG. 8 is a flowchart illustrating a method for controlling a beacon signal of an electronic device according to an embodiment of the present disclosure;

FIG. 9 is a view illustrating a transmission period of a beacon signal changing according to an embodiment of the present disclosure;

FIG. 10 is a view illustrating transmission power of a beacon signal changing according to an embodiment of the present disclosure;

FIG. 11 is a flowchart illustrating a method for controlling a beacon signal of an electronic device according to an embodiment of the present disclosure;

FIG. 12 is a view illustrating an electronic device controlling a beacon signal based on a motion sensor according to an embodiment of the present disclosure;

FIGS. 13A and 13B are views illustrating an electronic device controlling a beacon signal based on a position sensor according to various embodiments of the present disclosure;

FIG. 14 is a view illustrating an electronic device controlling a beacon signal based on a fingerprint sensor according to an embodiment of the present disclosure;

FIG. 15 is a view illustrating an electronic device controlling a beacon signal based on an acceleration sensor according to an embodiment of the present disclosure;

FIG. 16 is a view illustrating an electronic device controlling a beacon signal based on a geomagnetic sensor according to an embodiment of the present disclosure;

FIG. 17 is a view illustrating an electronic device controlling a beacon signal based on a camera sensor according to an embodiment of the present disclosure;

FIG. 18 is a view illustrating an electronic device controlling a beacon signal based on a microphone sensor according to an embodiment of the present disclosure; and

FIG. 19 is a view illustrating an electronic device controlling a beacon signal based on a heart rate measuring unit according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Expressions such as “include” or “may include,” etc. that may be used for the present disclosure indicate existence of a disclosed relevant function, operation, or element, etc., and do not limit additional one or more functions, operations, or elements, etc. Also, it should be understood that terminologies such as “include” or “have,” etc. in the present disclosure are intended for designating existence of a characteristic, a number, a step, an operation, an element, a part, or a combination of these described on the specification and do not exclude in advance existence or addition possibility of one or more other characteristics, numbers, steps, operations, elements, parts, or a combination of these.

Expression such as “or,” etc. in the present disclosure includes a certain and all combinations of words listed together. For example, “A or B” may include A and may include B, or include both A and B. In the present disclosure, expressions such as “1^{st},” “2^{nd},” “first” or “second,” etc. may modify various elements of the present disclosure but do not limit relevant elements. For example, the expressions do not limit sequence and/or importance, etc. of relevant elements. The expressions may be used for discriminating one element from another element. For example, both a first user apparatus and a second user apparatus are all user apparatuses, and represent different user apparatuses. For example, a first element may be named as a second element without departing from the scope of the present disclosure, and similarly, the second element may be named as the first element.

When it is mentioned that a certain element is “connected to” or “accesses” another element, it should be understood that the element may be directly connected to another element or may directly access another element, but still another element may exist in the middle. In contrast, when it is mentioned that a certain element is “directly connected to” or “directly accesses” another element, it should be understood that still another element does not exist in the middle.

A terminology used in the present disclosure is used for explaining only a specific embodiment and is not intended for limiting the present disclosure. Unless clearly expressed otherwise, expression of the singular includes expression of the plural. Unless defined differently, all terminologies used herein including technological or scientific terminologies have the same meaning as that generally understood by a person of ordinary skill in the art to which the present disclosure belongs. It should be understood that generally used terminologies defined by a dictionary have meaning coinciding with meaning on context of a related technology, and unless clearly defined in the present disclosure, they are not understood as an ideal or excessively formal meaning.

An electronic device according to the present disclosure may be a device including a communication function. For example, an electronic device may include at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, a camera, or a wearable device (e.g., a Head-Mounted-Device (HMD) such as electronic glasses, an electronic clothing, an electronic bracelet, an electronic necklace, an electronic appcessory, an electronic tattoo, or a smartwatch).

According to certain embodiments, an electronic device may be a smart home appliance having a communication function. A smart home appliance may include, for example, at least one of a television, a Digital Video Disk (DVD) player, an audio player, a refrigerator, an air conditioner, a cleaner, an oven, an electronic range, a washing machine, an air purifier, a set-top box, a TV box (for example, Samsung HomeSync™, Apple TV™, or Google TV™), game consoles, an electronic dictionary, an electronic key, a camcorder, or an electronic frame.

According to certain embodiments, an electronic device may include at least one of various medical devices (e.g., Magnetic Resonance Angiography (MRA), Magnetic Resonance Imaging (MRI), Computed Tomography (CT), a shooting device, an ultrasonic device, etc.), a navigation device, a Global Positioning System (GPS) receiver, an Event Data Recorder (EDR), a Flight Data Recorder (FDR), an automobile infotainment device, electronic equipment for a ship (e.g., a navigation device for a ship, a gyro compass, etc.), an avionics, a security device, a head unit for a vehicle, a robot for an industrial use or a home use, an automatic teller's machine of a financial institution, or a point of sales of a store.

According to certain embodiments, an electronic device may include at least one of a furniture or a portion of a building/structure including a communication function, an electronic board, an electronic signature receiving device, a projector, or various measurement devices (e.g., a water measurement device, an electricity measurement device, a gas measurement device, and/or a radio wave measuring device, etc.). An electronic device according to the present disclosure may be a combination of one or more of the above-described devices. Also, it is obvious to a person of ordinary skill in the art that the electronic device according to the present disclosure is not limited to the above-described devices.

Hereinafter, an electronic device according to various embodiments of the present disclosure is described with reference to the accompanying drawings. A terminology of a user used in various embodiments of the present disclosure may indicate a person who uses an electronic device or a device (e.g., an artificial intelligence electronic device) that uses the electronic device.

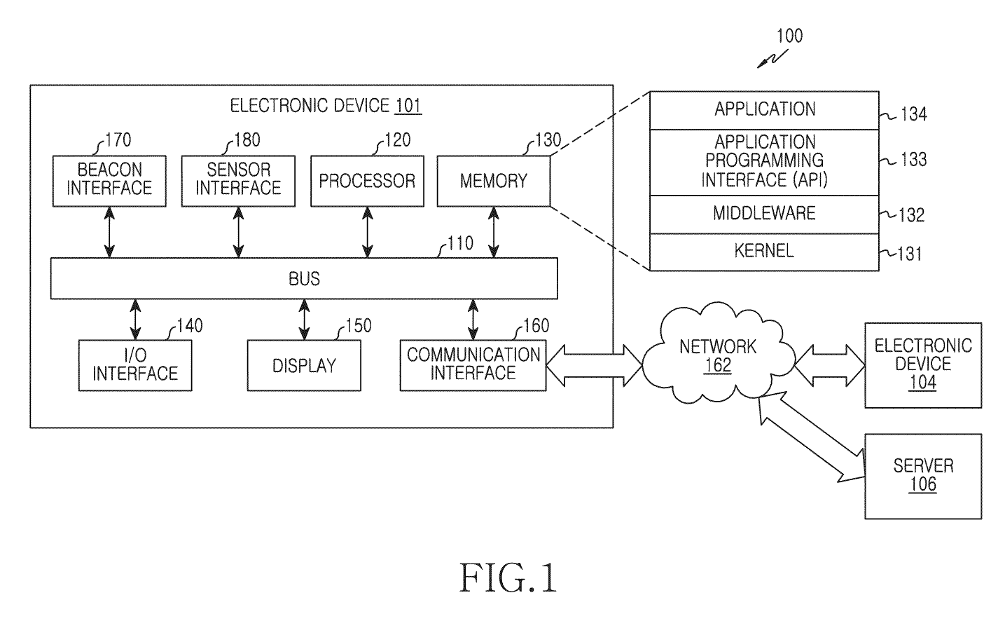

FIGS. 1 through 19, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

FIG. 1 is a view illustrating a network environment including an electronic device according to an embodiment of the present disclosure.

Referring to FIG. 1, a network environment 100 is illustrated, where the network environment 100 may include an electronic device 101, which may include a bus 110, a processor 120, a memory 130, an input/output (I/O) interface 140, a display 150, a communication interface 160, a beacon interface 170, and a sensor interface 180, etc.

The beacon interface 170 is an element for transmitting/receiving a beacon signal. The beacon interface 170 may be included in the communication interface 160 or may be a separate element, and may cooperate with the processor 120. The sensor interface 180 is an element for receiving information of various sensors such as a motion sensor, a position sensor, a fingerprint sensor, an acceleration sensor, a geomagnetic sensor, and a heart rate measuring unit, etc. The sensor interface 180 may cooperate with the processor 120.

The bus 110 may be a circuit for connecting the above-described elements with each other, and transferring communication (e.g., a control message) between the above-described elements. The processor 120 may receive, for example, an instruction from the above-described other elements (e.g., the memory 130, the I/O interface 140, the display 150, the communication interface 160, etc.) via the bus 110, decipher the received instruction, and execute an operation or a data process corresponding to the deciphered instruction.

The memory 130 may store an instruction or data received from the processor 120 or other elements (e.g., the I/O interface 140, the display 150, the communication interface 160, etc.), or generated by the processor 120 or other elements. The memory 130 may include, for example, programming modules such as a kernel 131, a middleware 132, an application programming interface (API) 133, and/or an application 134. The each of the programming modules may be configured using a software, a firmware, a hardware, or a combination of two or more of these.

The kernel 131 may control or manage system resources (e.g., the bus 110, the processor 120, or the memory 130, etc.) used for executing an operation or a function implemented in the rest of the programming modules, for example, the middleware 132, the API 133, or the application 134. Also, the kernel 131 may provide an interface for allowing the middleware 132, the API 133, or the application 134 to access an individual element of the electronic device 101 and control or manage the same.

The middleware 132 may perform a mediation role so that the API 133 or the application 134 may communicate with the kernel 131 to give and take data. Also, in connection with task requests received from the applications 134, the middleware 132 may perform a control (e.g., scheduling or load balancing) for a task request using, for example, a method of assigning priority that may use a system resource (e.g., the bus 110, the processor 120, or the memory 130, etc.) of the electronic device 101 to at least one of the applications 134.

The API 133 is an interface for allowing the application 134 to control a function provided by the kernel 131 and/or the middleware 132, and may include, for example, at least one interface or function (e.g., an instruction) for file control, window control, image processing, or character control, etc.

According to various embodiments of the present disclosure, the application 134 may include a Short Messaging Service (SMS)/Multimedia Messaging Service (MMS) application, an e-mail application, a calendar application, an alarm application, a health care application (e.g., an application for measuring quantity of motion and/or blood sugar, etc.), and/or an environment information application (e.g., an application providing atmospheric pressure, humidity or temperature information, etc.). Additionally or alternatively, the application 134 may be an application related to information exchange between the electronic device 101 and an external electronic device (e.g., electronic device 104). The application related to the information exchange may include, for example, a notification relay application for transferring specific information to the external electronic device or a device management application for managing the external electronic device.

For example, the notification relay application may include a function for transferring notification information generated from a different application (e.g., an SMS/MMS application, an e-mail application, a health care application, or an environment information application) of the electronic device 101 to an external electronic device (e.g., the electronic device 104). Additionally or alternatively, the notification relay application may, for example, receive notification information from an external electronic device (e.g., the electronic device 104) and provide the same to a user. The device management application may manage (e.g., install, delete, or update) a function (e.g., turn-on/turn-off of an external electronic device itself (or some constituent part) or luminance (or resolution) control of a display) of an external electronic device (e.g., the electronic device 104) communicating with the electronic device 101 and an application operating in the external electronic device or a service (e.g., a communication service or a message service) provided by the external electronic device.

According to various embodiments of the present disclosure, the application 134 may include a designated application depending on an attribute (e.g., a kind of an electronic device) of the external electronic device (e.g., the electronic device 104). For example, in a case where the external electronic device is an MP3 player, the application 134 may include an application related to music reproduction. Similarly, in a case where the external electronic device is a mobile medical health care device, the application 134 may include an application related to health care. According to an embodiment, the application 134 may include at least one of an application designated in the electronic device 101 and an application received from the external electronic device (e.g., a server 106 or the electronic device 104).

The I/O interface 140 may transfer an instruction or data input from a user via an I/O unit (e.g., a sensor, a keyboard, or a touchscreen) to the processor 120, the memory 130, and the communication interface 160, via the bus 110, for example. For example, the I/O interface 140 may provide data regarding a user's touch input via the touchscreen to the processor 120. Also, the I/O interface 140 may, for example, output an instruction or data received via the bus 110 from the processor 120, the memory 130, and the communication interface 160 via the I/O unit (e.g., a speaker or a display). For example, the I/O interface 140 may output voice data processed by the processor 120 to a user via a speaker.

The display 150 may display various information (e.g., multimedia data and/or text data, etc.) to a user. The communication interface 160 may connect communication between the electronic device 101 with an external device (e.g., the electronic device 104 and/or the server 106). For example, the communication interface 160 may be connected with a network 162 via wireless communication and/or wired communication to communicate with the external device. The wireless communication may, for example, include at least one of Wireless Fidelity (Wi-Fi), Bluetooth (BT), Near Field Communication (NFC), GPS, and/or cellular communication (e.g., Long-Term Evolution (LTE), Long-Term Evolution-Advanced (LTE-A), Code-Division Multiple Access (CDMA), Wideband Code-Division Multiple Access (WCDMA), Universal Mobile Telecommunications System (UMTS), Wireless Broadband (WiBro), and/or GSM, etc.). The wired communication may include, for example, at least one of Universal Serial Bus (USB), High Definition Multimedia Interface (HDMI), recommended standard 232 (RS-232), and plain old telephone service (POTS).

According to an embodiment of the present disclosure, the network 162 may be a telecommunications network. The telecommunications network may include at least one of a computer network, the Internet, an Internet of things, and a telephone network. According to an embodiment, a protocol (e.g., a transport layer protocol, a data link layer protocol, or a physical layer protocol) for communication between the electronic device 101 and an external device may be supported by at least one of the application 134, the application programming interface 133, the middleware 132, the kernel 131, or the communication interface 160.

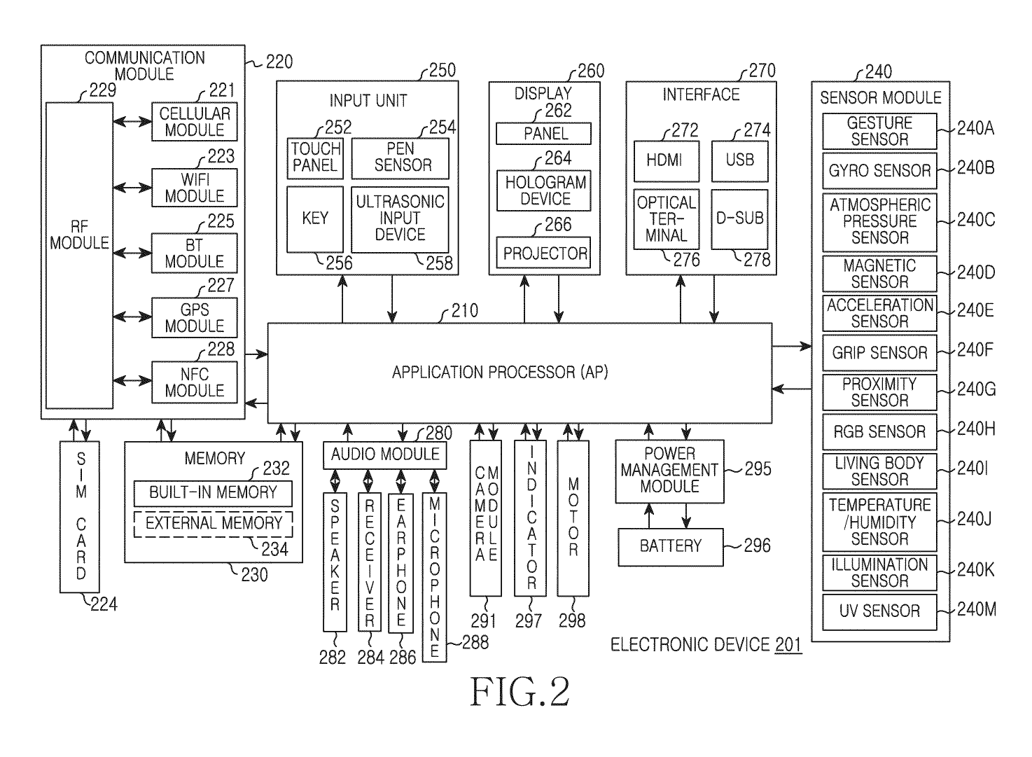

FIG. 2 is a block diagram illustrating an electronic device according to an embodiment of the present disclosure. The electronic device may configure, for example, all or a portion of the electronic device 101 illustrated in FIG. 1.

Referring to FIG. 2, an electronic device 201 is illustrated, where the electronic device 201 may include one or more of an Application Processor (AP) 210, a communication module 220, a Subscriber Identification Module (SIM) card 224, a memory 230, a sensor module 240, an input unit 250, a display 260, an interface 270, an audio module 280, a camera module 291, a power management module 295, a battery 296, an indicator 297, an a motor 298.

The AP 210 may drive an Operating System (OS) or an application to control a plurality of hardware or software elements connected to the AP 210, and perform various data processes including multimedia data and operations. The AP 210 may be implemented, for example, as a System On Chip (SoC). According to an embodiment, the AP 210 may further include a Graphic Processing Unit (GPU) (not shown).

The communication module 220 (e.g., the communication interface 160) may perform data transmission/reception in communication between the electronic device 201 (e.g., the electronic device 101) and other electronic devices (e.g., the electronic device 104 or the server 106) connected via a network. According to an embodiment, the communication module 220 may include a cellular module 221, a Wi-Fi module 223, a BT module 225, a GPS module 227, an NFC module 228, and a Radio Frequency (RF) module 229.

The cellular module 221 may provide voice communication, image communication, a short message service, or an Internet service, etc. via a communication network (e.g., LTE, LTE-A, CDMA, WCDMA, UMTS, WiBro, and/or GSM, etc.). Also, the cellular module 221 may perform discrimination and authentication of an electronic device within a communication network using, for example, a subscriber identification module (e.g., a SIM card 224). According to an embodiment, the cellular module 221 may perform at least a portion of functions that may be provided by the AP 210. For example, the cellular module 221 may perform at least a portion of a multimedia control function.

According to an embodiment, the cellular module 221 may include a communication processor (CP). Also, the cellular module 221 may be, for example, implemented as an SoC. Though elements such as the cellular module 221 (e.g., a communication processor), the memory 230, and/or the power management module 295, etc. are illustrated as elements separated from the AP 210 in FIG. 2, according to an embodiment, the AP 210 may be implemented to include at least a portion (e.g., the cellular module 221) of the above-described elements.

According to an embodiment of the present disclosure, the AP 210 or the cellular module 221 (e.g., a communication processor) may load an instruction or data received from at least one of a non-volatile memory and other elements connected thereto onto a volatile memory, and process the same. Also, the AP 210 and/or the cellular module 221 may store data received from at least one of other elements or generated by at least one of other elements in a non-volatile memory.

Each of the Wi-Fi module 223, the BT module 225, the GPS module 227, or the NFC module 228 may include, for example, a processor for processing data transmitted/received via a relevant module. Though the cellular module 221, the Wi-Fi module 223, the BT module 225, the GPS module 227, or the NFC module 228 are illustrated as separate blocks in FIG. 2, according to an embodiment, at least a portion (e.g., two or more elements) of the cellular module 221, the Wi-Fi module 223, the BT module 225, the GPS module 227, or the NFC module 228 may be included in one Integrated Circuit (IC) or an IC package. For example, at least a portion (e.g., a communication processor corresponding to the cellular module 221 and a Wi-Fi processor corresponding to the Wi-Fi module 223) of processors corresponding to the cellular module 221, the Wi-Fi module 223, the BT module 225, the GPS module 227, or the NFC module 228, respectively, may be implemented as one SoC.

The RF module 229 may perform transmission/reception of data, for example, transmission/reception of an RF signal. The RF module 229 may include, for example, a transceiver, a Power Amp Module (PAM), a frequency filter, or a Low Noise Amplifier (LNA), etc., though not shown. Also, the RF module 229 may further include a part for transmitting/receiving an electromagnetic wave on a free space in wireless communication, for example, a conductor or a conducting line, etc. Though FIG. 2 illustrates the cellular module 221, the Wi-Fi module 223, the BT module 225, the GPS module 227, and the NFC module 228 share one RF module 229, according to an embodiment, at least one of the cellular module 221, the Wi-Fi module 223, the BT module 225, the GPS module 227, or the NFC module 228 may perform transmission/reception of an RF signal via a separate RF module.

The SIM card 224 may be a card including a subscriber identification module, and may be inserted into a slot formed in a specific position of the electronic device. The SIM card 224 may include unique identify information (e.g., Integrated Circuit Card Identifier (ICCID)) or subscriber information (e.g., International Mobile Subscriber Identity (IMSI)).

The memory 230 (e.g., the memory 130) may include a built-in memory 232 or an external memory 234. The built-in memory 232 may include, for example, at least one of a volatile memory (e.g., Dynamic RAM (DRAM), Static RAM (SRAM), Synchronous Dynamic RAM (SDRAM)) and a non-volatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, NAND flash memory, NOR flash memory, etc.).

According to an embodiment, the built-in memory 232 may be a Solid State Drive (SSD). The external memory 234 may further include a flash drive, for example, Compact Flash (CF), Secure Digital (SD), Micro Secure Digital (Micro-SD), Mini Secure Digital (Mini-SD), Extreme Digital (xD), and/or a memory stick. The external memory 234 may be functionally connected with the electronic device 201 via various interfaces. According to an embodiment, the electronic device 201 may further include a storage device (or a storage medium) such as a hard drive.

The sensor module 240 may measure a physical quantity or detect an operation state of the electronic device 201, and convert the measured or detected information to an electric signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a Red, Blue, Green (RGB) sensor), a living body sensor 240I, a temperature/humidity sensor 240J, an illuminance/illumination sensor 240K, and/or an Ultra Violet (UV) sensor 240M. Additionally or alternatively, the sensor module 240 may include, for example, an E-nose sensor (not shown), an Electromyography (EMG) sensor (not shown), an Electroencephalogram (EEG) sensor (not shown), an Electrocardiogram (ECG) sensor (not shown), an Infrared (IR) sensor (not shown), an iris sensor (not shown), a fingerprint sensor (not shown), a geomagnetic sensor (not shown), a heart rate monitor (not shown), etc. The sensor module 240 may further include a control circuit for controlling at least one sensor belonging thereto.

The input unit 250 may include a touch panel 252, a (digital) pen sensor 254, a key 256, and/or an ultrasonic input device 258. The touch panel 252 may detect a touch input using at least one of capacitive, resistive, infrared, or ultrasonic methods. Also, the touch panel 252 may further include a control circuit. A capacitive touch panel may perform detection by a physical contact or proximity detection. The touch panel 252 may further include a tactile layer. In this case, the touch panel 252 may provide a tactile reaction to a user.

The (digital) pen sensor 254 may be implemented using, for example, a method which is the same as or similar to receiving a user's touch input, or using a separate sheet for detection. The key 256 may include, for example, a physical button, an optical key or keypad. The ultrasonic input device 258 is for recognizing data by detecting a sound wave using a microphone (e.g., a microphone 288) in the electronic device 201 via an input tool generating an ultrasonic signal, and enables wireless recognition. According to an embodiment, the electronic device 201 may receive a user input from an external device (e.g., a computer or a server) connected to the communication module 220 using the communication module 220.

The display 260 (e.g., the display 150) may include a panel 262, a hologram device 264, and/or a projector 266. The panel 262 may be, for example, a liquid crystal display (LCD), and/or an active-matrix organic light-emitting diode (AM-OLED), etc. The panel 262 may be implemented, for example, such that it is flexible, transparent, or wearable. The panel 262 may be configured as one module together with the touch panel 252. The hologram device 264 may show a three-dimensional image in the air using interferences of light. The projector 266 may project light onto a screen to display an image. The screen may be positioned, for example, inside or outside the electronic device 201. According to an embodiment, the display 260 may further include a control circuit for controlling the panel 262, the hologram device 264, and/or the projector 266.

The interface 270 may include, for example, a HDMI 272, a USB 274, an optical interface/terminal 276, or a D-subminiature (D-sub) 278. The interface 270 may be included, for example, in the communication interface 160 illustrated in FIG. 1. Additionally or alternatively, the interface 270 may include, for example, a Mobile High-definition Link (MHL) interface, a Secure Digital (SD) card/Multi-Media Card (MMC) interface, and/or an Infrared Data Association (IrDA) standard interface.

The audio module 280 may convert a sound and an electric signal in dual directions. At least a partial element of the audio module 280 may be included, for example, in the I/O interface 140 illustrated in FIG. 1. The audio module 280 may process sound information input or output via, for example, a speaker 282, a receiver 284, an earphone 286, and/or the microphone 288, etc.

The camera module 291 is a device that may shoot a still image and a moving picture. According to an embodiment, the camera module 291 may include one or more image sensors (e.g., a front sensor or a rear sensor), a lens (not shown), an Image Signal Processor (ISP) (not shown), or a flash (not shown) (e.g., an LED or xenon lamp). The power management module 295 may manage power of the electronic device 201. Though not shown, the power management module 295 may include, for example, a Power Management Integrated Circuit (PMIC), a charger Integrated Circuit (IC), or a battery or a fuel gauge.

The PMIC may be mounted, for example, inside an integrated circuit or an SoC semiconductor. A charging method may be classified into a wired charging method and a wireless charging method. The charging IC may charge a battery and prevent introduction of an overvoltage or an overcurrent from a charger. According to an embodiment, the charging IC may include a charging IC for at least one of the wired charging method and the wireless charging method. The wireless charging method may be, for example, a magnetic resonance method, a magnetic induction method, or an electromagnetic wave method, etc., and may additionally include an additional circuit for wireless charging, for example, a circuit such as a coil loop, a resonance circuit, or a rectifier, etc.

The battery gauge may measure, for example, a remnant of the battery 296, a voltage, a current, or a temperature while charging. The battery 296 may store or generate electricity, and supply power to the electronic device 201 using the stored or generated electricity. The battery 296 may include, for example, a rechargeable battery or a solar battery.

The indicator 297 may display a specific state of the electronic device 201 or a portion thereof (e.g., the AP 210), for example, a booting state, a message state, or a charging state, etc. The motor 298 may convert an electric signal to mechanical vibration. Though not shown, the electronic device 210 may include a processor (e.g., a GPU) for supporting a mobile TV. The processor for supporting the mobile TV may process media data corresponding to standards, for example, such as Digital Multimedia Broadcasting (DMB), Digital Video Broadcasting (DVB), or a media flow, etc.

Each of the above-described elements of the electronic device according to the present disclosure may be configured using one or more components, and a name of a relevant element may change depending on a kind of the electronic device. An electronic device according to the present disclosure may include at least one of the above-described elements, and a portion of the elements may be omitted, or additional other elements may be further included. Also, a portion of the elements of the electronic device according to the present disclosure may combine to form one entity and equally perform a function of the relevant elements before the combination.

Hereinafter, a method for controlling a beacon signal of an electronic device and an electronic device thereof according to various embodiments of the present disclosure are described in detail. An electronic device according to various embodiments of the present disclosure may be various types of electronic devices such as a smartphone or a tablet PC, etc., and may include the elements illustrated in FIGS. 1 and 2.

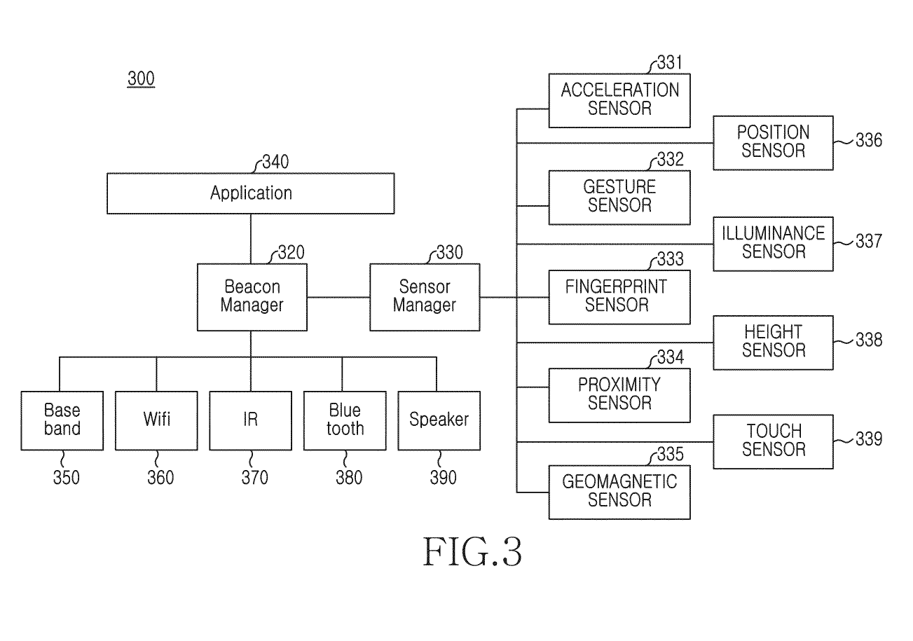

FIG. 3 is a view illustrating a portion of an electronic device to which an embodiment of the present disclosure is applied.

Referring to FIG. 3, an electronic device 300 is illustrated, where the electronic device 300 may include a beacon manager 320, a sensor manager 330, an application 340, a baseband module 350, a Wi-Fi module 360, an infrared (IR) module 370, a Bluetooth module 380, a speaker 390, etc.

The sensor manager 330 may manage various sensors such as an acceleration sensor 331, a gesture sensor 332, a fingerprint sensor 333, a proximity sensor 334, a geomagnetic sensor 335, a position sensor 336, an illuminance sensor 337, a height sensor 338, a touch sensor 339, etc., and may be integrated as one element together with the beacon manager 320, and/or cooperate as a separate element with the beacon manager 320.

As the application 340 is executed, the beacon manager 320 may drive the at least one module (e.g., the baseband module), and the module may output a beacon signal received via a wireless network to the beacon manager 320. The beacon manager 320 may dynamically control a transmission/reception operation of a beacon signal based on various sensor information input via the sensor manager 330.

The beacon manager 320 may control a transmission operation of a beacon signal generated by the application 340, or directly generate a beacon signal according to a request of the application 340. The beacon manager 320 may be included inside the application and may manage a beacon operation for each application, and may exist outside the application to manage a beacon operation of various applications.

Furthermore, the beacon manager 320 may be included in each of the baseband module 350, the Wi-Fi module 360, the Infrared (IR) module 370, the Bluetooth module 380, the speaker 390, etc. A beacon operation is controlled by a control instruction generated by the beacon manager 320, and the beacon signal is transmitted (e.g., broadcast) via a module that may transmit/receive the beacon. Here, a module that may transmit/receive the beacon signal may include a baseband module, a Wi-Fi module, an IR module, a Bluetooth module, a speaker, etc.

The baseband module may transmit/receive a beacon signal that may be communicated in a mobile network such as a GSM, a UMTS, an LTE, etc. The Wi-Fi module may transmit/receive a beacon signal suitable for a communication standard 802.11. The IR module may transmit/receive a beacon signal using an infrared sensor, and the Bluetooth module may transmit/receive a beacon signal suitable for the Bluetooth communication standard. The speaker transmits/receives a signal via a sound. The speaker may transmit/receive a beacon signal that incorporates specific information into a non-audible note or an audible note. A beacon signal may be transmitted/received via various modules besides the above-mentioned module.

The beacon manager 320 may utilize various sensor information received from the sensor manager 330 in controlling a beacon operation. The sensor manager 330 is a module for managing a sensor value collected from various sensors, and is a module for using a sensor value with low power.

Sensors managed by the sensor manager 330 include an acceleration sensor 331, a geomagnetic sensor 335, a gyro sensor, a position sensor 336 such as a GPS, etc., a gesture (e.g., a motion) sensor 332, an illuminance sensor 337, a fingerprint sensor 333, a height sensor 338, a proximity sensor 334, a touch sensor 339, a camera sensor, a microphone sensor, a Heart Rate Monitor (HRM) sensor, an oxygen saturation measuring sensor, a stress measuring sensor, a brainwave sensor, etc. Various sensors may be managed besides the above mentioned sensors.

According to various embodiments of the present disclosure, a sensor value may be received from the sensor manager 330, and the sensor manager 330 may not exist. Furthermore, management of the sensor manager 330 may not be required. That is, the beacon manager 320 may directly receive a sensor value from each sensor and utilize the same for beacon operation control.

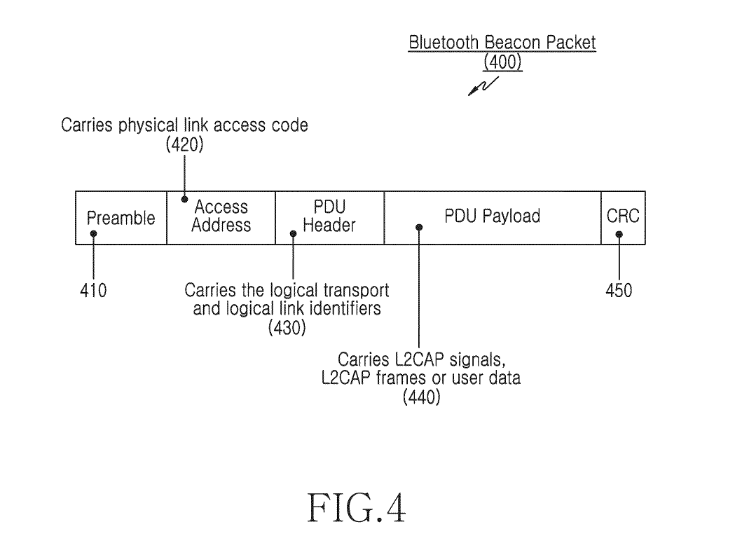

FIG. 4 is a view illustrating a construction of a BLE beacon packet according to an embodiment of the present disclosure.

Referring to FIG. 4, a BLE beacon packet 400 is illustrated, where the BLE beacon packet 400 may include a preamble 410, an access address 420, a Packet Data Unit (PDU) header 430, a PDU payload 440, a Cyclical Redundancy Check (CRC) 450, etc.

The preamble 410 may include information related to frequency synchronization, symbol timing estimation, automatic gain control, etc. The access address 420 may include information related to a physical link access code, etc. The PDU header 430 may include information related to logical transport, logical link identifiers, etc.

The PDU payload 440 may include information related to a Logical Link Control and Adaptation Protocol (L2CAP) signal, L2CAP frames, or user data, etc. The CRC 450 may include information related to data transmission error detection, etc. The user data may be, for example, media data such as audio, video, text, etc. related to advertising, etc.

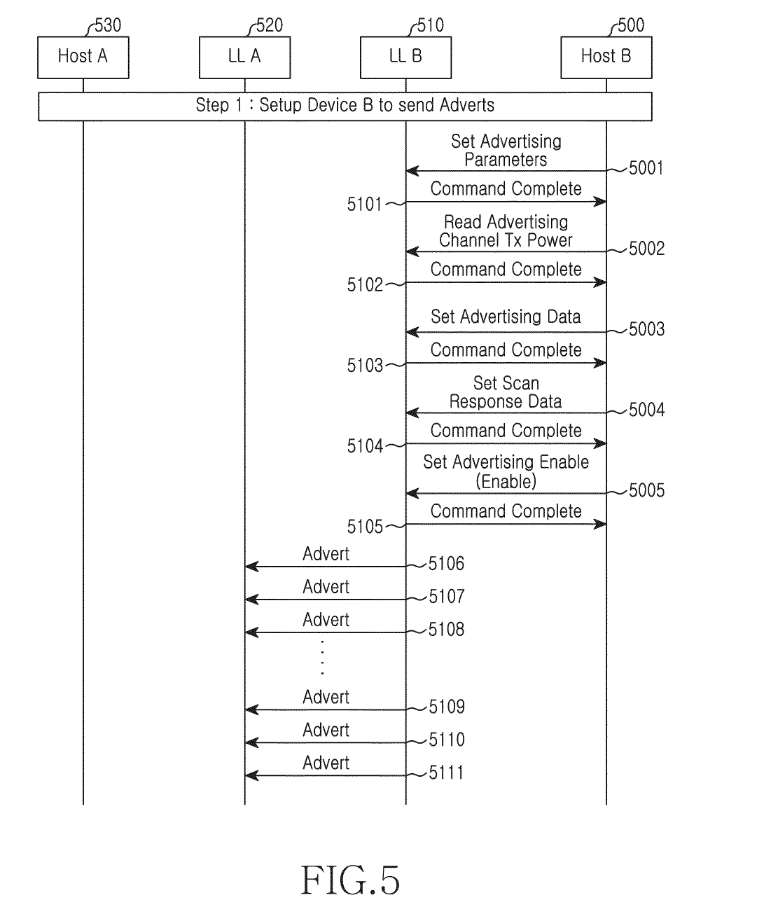

FIG. 5 is a view illustrating a transmission process of a beacon signal according to an embodiment of the present disclosure.

Referring to FIG. 5, transmission process is illustrated, where a host B 500 which is one of various types of electronic devices such as a smartphone or a tablet PC, etc. generates a beacon signal and transmits (e.g., advertising) the same to a host A 530 which is another electronic device.

To generate a beacon signal, the host B 500 sequentially performs operations of setting advertising parameters 5001, reading advertising channel Tx power 5002, setting advertising data 5003, setting scan response data 5004, and setting advertising enable 5005 on a Link Layer B (LLB) 510 corresponding to a beacon communication module.

The link layer B 510 performs operations of command completes 5101, 5102, 5103, 5104, 5105 that respond to the above operations, and performs transmission operations 5106, 5107, 5108, 5109, 5110 and 5111 that transmit (e.g., advertising) a beacon signal generated through the above processes to a neighboring terminal, such as LLA 520.

The operation of setting advertising parameters 5001 is to set values included in advertising parameters.

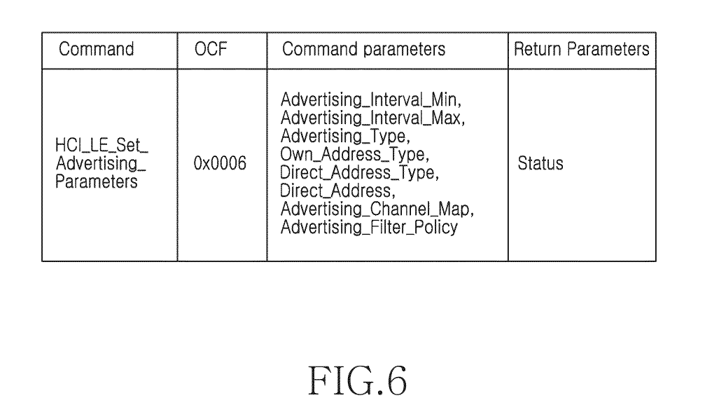

FIG. 6 is a view illustrating a construction of a set advertisement parameter according to an embodiment of the present disclosure.

Referring to FIG. 6, a command, OCF (OpCode Command Field), command parameters and return parameters are illustrated. Specifically, for example, a transmission period of a beacon signal may be set in an advertising interval field. A public device address or a random device address that is to receive a beacon signal may be set in a direct address field.

The operation of reading advertising channel Tx power 5002 is an operation of reading a transmission power level used for transmitting an advertising channel packet. The operation of setting advertising data 5003 is an operation of setting data to transmit via a beacon signal.

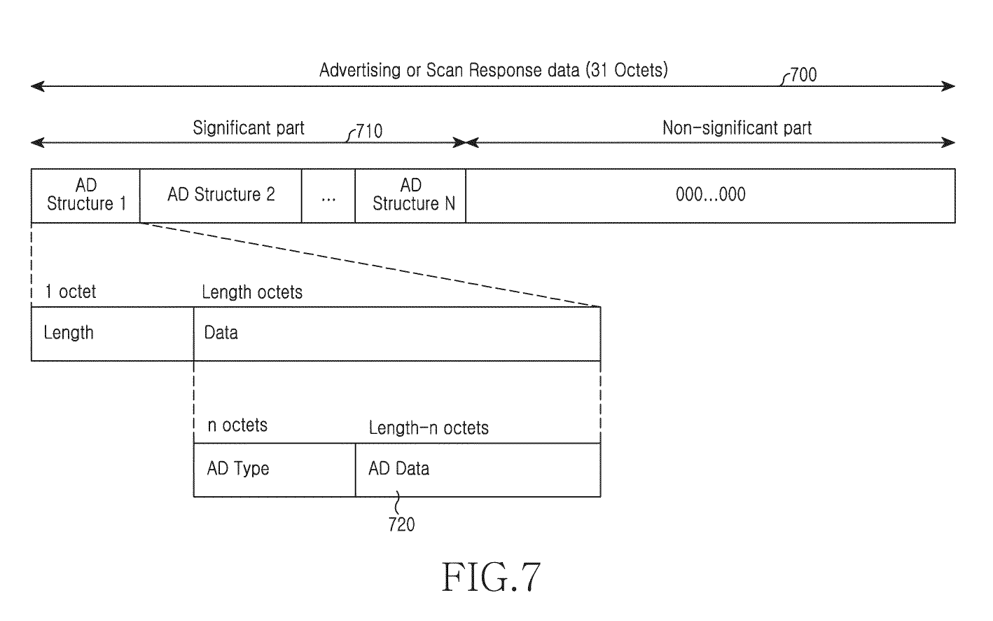

FIG. 7 is a view illustrating a construction of a set advertisement parameter according to an embodiment of the present disclosure.

Referring to FIG. 7, an advertising or scan response data 700 is illustrated, where the advertising or scan response data 700 is configured using octects (or bytes). Only a significant part 710 of FIG. 7 is transmitted via a beacon signal, and a non-significant part filled with null data to make a data length of 31 octects is excluded from transmission.

Each Advertising (AD) Structure 1 . . . N includes length and data information, where the data information includes AD Type and AD Data 720. The AD data 720 of FIG. 7 includes, for example, Service Universally Unique Identifiers (UUIDs), Local Name, Flags, Manufacturer Specific Data, TX Power Level, Security Manager Out of Band (OOB), Security Manager TK Value, Slave Connection Interval Range, Service Solicitation, Service Data, etc.

The Manufacturer Specific Data is a field for incorporating contents designated by a manufacturer, and may incorporate various contents such as advertisements or URL, etc. and transmit the same. In the operation of setting advertising enable 5005, advertising start or stop may be requested.

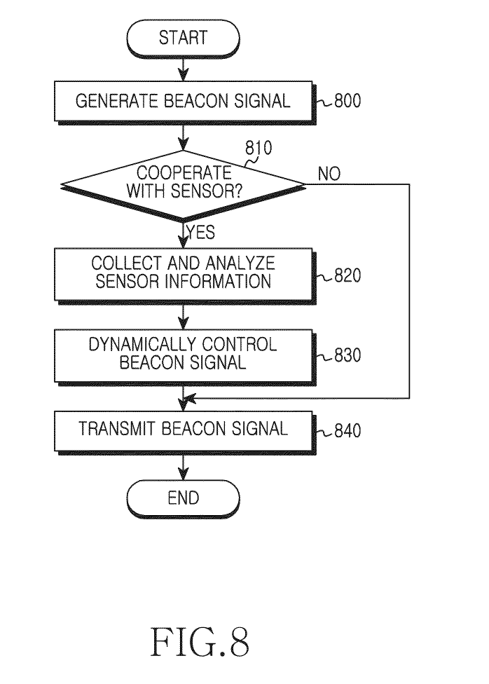

FIG. 8 is a flowchart illustrating a method for controlling a beacon signal of an electronic device according to an embodiment of the present disclosure.

Referring to FIG. 8, a flowchart is illustrated, where, for example, a processor of an electronic device such as a smartphone or a tablet PC, etc. may generate the beacon signal in response to a beacon signal received from neighborhood, a beacon signal may be generated at a specific position, or may be generated by an application driven by a user in operation 800.

The processor determines whether the beacon signal cooperates with a sensor in operation 810. When the beacon signal cooperates with the sensor as a result of the determination, the processor collects and analyzes sensor information in operation 820, and dynamically controls the generated beacon signal in operation 830. For example, the processor may change contents included in the beacon signal, change a transmission/reception period of the beacon signal, change an object that is to receive the beacon signal, change encryption of the beacon signal, or change transmission power of the beacon signal, etc. based on the collected sensor information.

The processor performs an operation of transmitting the dynamically controlled beacon signal as described above, or when the beacon signal does not cooperate with the sensor as a result of the determination, simply transmitting the beacon signal in operation 840. The beacon signal may be generated by three operations. First, when a beacon of a neighbor terminal is received, a beacon may be generated for responding to it. Second, a beacon may be generated at a specific position. For example, it is programmed that a specific area set in advance is scheduled to transmit (e.g., broadcasting) a beacon signal set in advance, a beacon signal may be generated when the electronic device enters the specific area or is positioned in the specific area, the electronic device may generate a beacon signal. Third, when an application is driven, a corresponding beacon signal may be generated.

The beacon signal may be generated by the beacon manager or generated by an application. The beacon manager determines whether the generated beacon signal cooperates with sensor information. When the beacon signal cooperates with the sensor information, a beacon active control process is performed. When the beacon signal does not cooperate with the sensor information, the beacon signal may be immediately transmitted.

When the beacon signal cooperates with the sensor information, the electronic device may collect the sensor information, and information of various sensors via the sensor manager, and collect sensor information from each sensor individually. A sensor measurement process for collecting the sensor information may be performed after whether the beacon signal cooperates with the sensor information is determined, and may be performed independently before. For example, sensor information is secured in advance via sensor measurement in the inside of a terminal regardless of whether a beacon signal is generated, and when the sensor information is required for controlling a beacon, the beacon manager may collect and utilize the sensor information secured in advance.

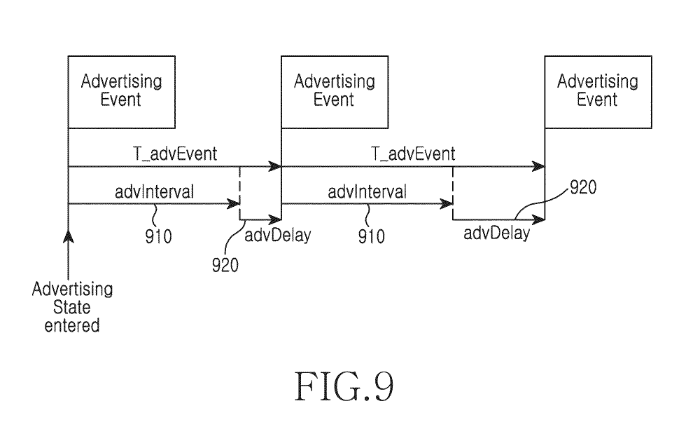

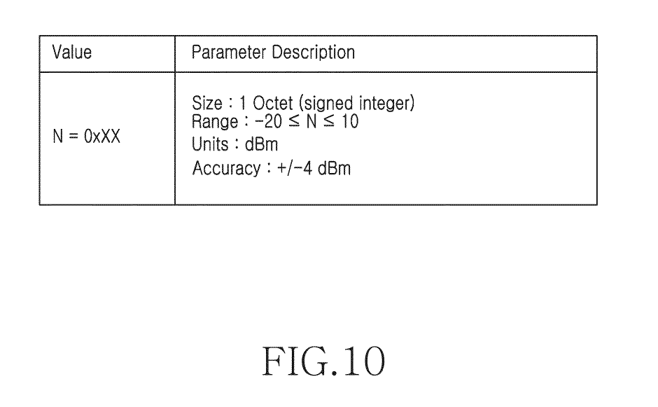

FIG. 9 is a view illustrating a transmission period of a beacon signal changing according to an embodiment of the present disclosure. The contents of FIG. 9 are described below with regard to changing the transmission/reception period of the beacon signal. FIG. 10 is a view illustrating transmission power of a beacon signal changing according to an embodiment of the present disclosure.

The collected sensor information may be sensor information measured by a sensor mounted inside a terminal, and may be sensor information measured by an apparatus outside the terminal or an accessory, etc. connected with the terminal. A process of dynamically controlling a beacon signal depending on the collected sensor information includes the following.

First, changing contents inside a beacon signal is to change content of a field value inside a beacon signal, for example, is to change content of contents included in AD data 720 of FIG. 7.

Second, referring to FIG. 9, changing a transmission/reception period of a beacon signal may be, for example, changing a transmission/reception period by changing an Advertising Interval (advInterval) 910 and an Advertising Delay (advDelay) 920, regarding an advertising packet, for each advertising event having a length of T_advEvent. A value of advInterval should be greater than 100 ms in case of, for example, a scannable undirected event type or a non-connectable undirected event type, and should be greater than 20 ms in case of a connectable undirected event type. A value of advDelay 920 may be a value arbitrarily generated from 0 ms to 10 ms. A transmission/reception period of a beacon signal may be changed by changing a value of advInterval 910 and a value of advDelay 920. For example, the number of times of transmission of a beacon signal may be changed to 5 times, 10 times, 20 times per second, etc. Also, a reception period of a beacon signal may be adjusted by changing a period of a scan operation for receiving a beacon signal.

Third, changing a reception object of a beacon signal is to change a broadcasting or advertisement reception object. For example, a family, a friend, a co-worker, etc. of a user of a terminal may be limited as a beacon reception object based on user information or terminal information registered in a phone book, a contact list inside the terminal, and a Social Network Service (SNS), etc. Here, device related information such as a Media Access Control (MAC) address, etc. of a counterpart terminal may be received from a network server, etc.

Fourth, changing encryption of a beacon signal is to encrypt a beacon signal and transmit the same, and an encryption degree may be changed depending on an encryption level. In a case where a beacon signal is not encrypted, all persons may decode the beacon. In a case where a beacon signal is encrypted, only a user of a terminal having information for encryption decoding may decode the beacon signal.

Fifth, referring to FIG. 10, changing transmission power of a beacon signal is to change a range which a beacon signal may reach by changing transmission power of a beacon signal. Transmission power of a beacon signal may be determined, for example, within a range from −20 dBm to +10 dBm as illustrated in FIG. 10. When the transmission power is changed, it may influence battery power consumption, a neighboring terminal interference, a range of a beacon signal, etc.

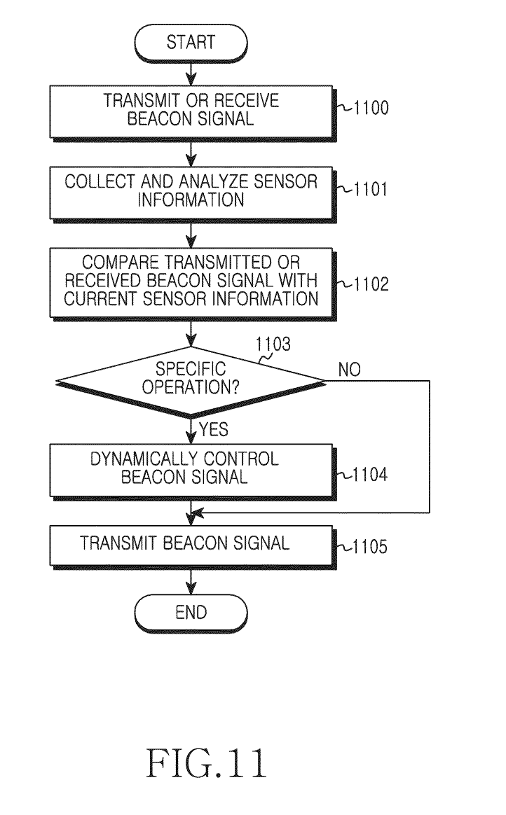

FIG. 11 is a flowchart illustrating a method for controlling a beacon signal of an electronic device according to an embodiment of the present disclosure.

Referring to FIG. 11, a flowchart is illustrated where, for example, a processor of an electronic device such as a smartphone or a tablet PC, etc. transmits or receives a beacon signal to a neighbor terminal, etc. in operation 1100, and collects and analyzes various sensor information in operation 1101.

The processor compares the transmitted or received beacon signal with current sensor information to analyze correlation in operation 1102, and determines whether a specific operation is required based on the correlation in operation 1103.

When the specific operation is required as a result of the determination, the processor dynamically controls generation of a beacon signal including contents, etc. suitable for the specific operation in operation 1104, and transmits the beacon signal in operation 1105. When the specific operation is not requires as a result of the determination in operation 1103, the processor transmits the beacon signal in operation 1105. Various embodiments thereof are described in detail.

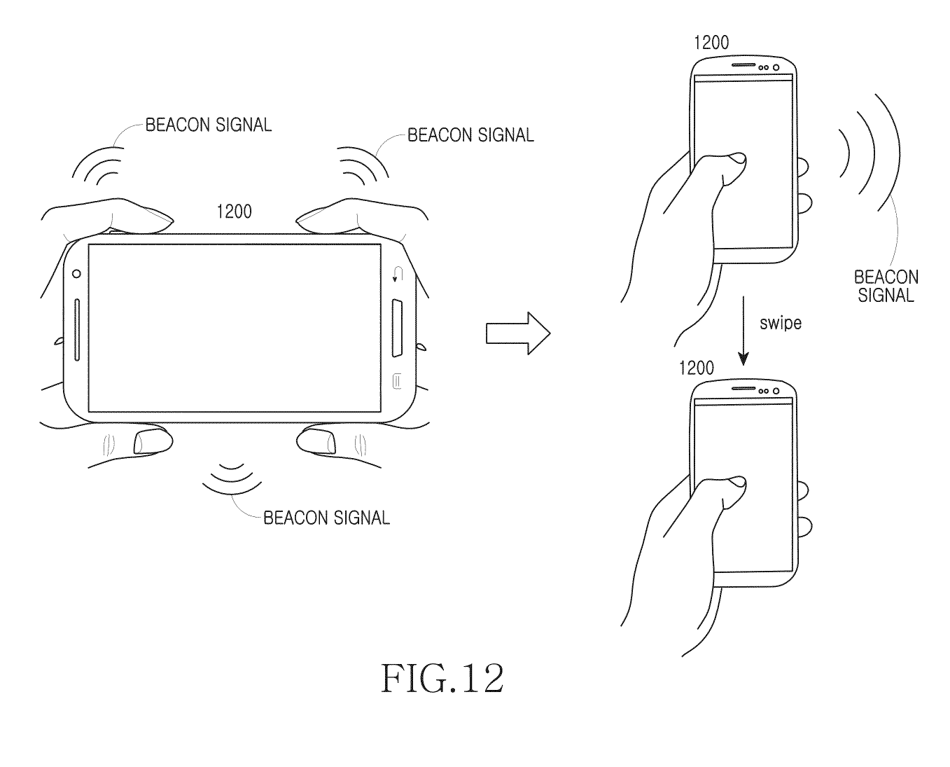

FIG. 12 is a view illustrating an electronic device controlling a beacon signal based on a motion sensor according to an embodiment of the present disclosure.

Referring to FIG. 12, a terminal 1200 is illustrated, where, for example, in a case where a user carrying the terminal 1200 enters a store and is positioned in front of goods to purchase, a processor of the terminal collects and analyzes various sensor information.

When detecting a motion where a user shoots a photo or a moving picture using a camera via a motion sensor, the processor may dynamically generate a beacon signal related to a camera based on motion information and transmit the same. Here, the transmitted beacon signal may be a beacon signal requesting information regarding goods shot by the camera or goods represented on a preview image, or a beacon signal requesting information regarding goods positioned in front of the user regardless of the camera image.

After that, when a motion where a user pays using a card, for example, a motion of moving a terminal 1200 up and down like paying using a card via a card terminal is detected, or when a motion of moving the terminal 1200 from the left to the right is detected, the processor of the terminal 1200 may dynamically generate a beacon signal related to card payment based on corresponding motion information and the transmitted beacon signal. For example, when a beacon signal transmitted within a reference time (e.g., 30 minutes) set in advance is a beacon signal requesting goods information and price, etc., or when a currently transmitted beacon signal is a beacon signal requesting goods payment sum and currently received sensor information is motion information corresponding to card payment, the processor may determine that a current operation is a card payment operation based on correlation between the beacon signal transmitted within the reference time or the current transmitted beacon signal, and currently received motion information, and automatically generate a beacon signal including contents, etc. corresponding to the card payment and transmit the same.

Therefore, as described above, the processor may dynamically generate a beacon signal based on motion (or gesture) sensor information of a terminal Here, when a beacon generated before a card payment motion (or gesture) is not a beacon requesting goods information, a beacon signal different from card payment may be generated afterward.

Meanwhile, as another embodiment, using touch sensor information, in a case where a user's touch input is swiped in a specific direction, for example, swiped from down to up, the processor may transmit a beacon signal in an upward direction of the terminal, and when swiped from left to right, the processor may transmit a beacon signal in the right direction of the terminal, thereby controlling a transmission direction of a beacon signal.

Furthermore, a beacon signal may be cooperated with a Smart Glass or a Smart Watch, etc. For example, the processor may recognize information regarding a direction or an object which the Smart Glass faces based on motion data or camera image data, etc., and then generate a beacon signal related thereto or transmit a beacon signal to a relevant direction.

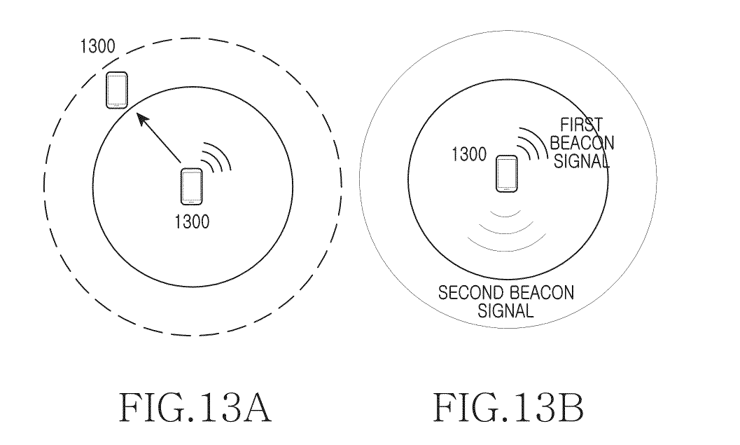

FIGS. 13A and 13B are views illustrating an electronic device controlling a beacon signal based on a position sensor according to an embodiment of the present disclosure.

Referring to FIG. 13A, for example, in a case where a terminal 1300 exists inside a specific area (a circle in a solid line of FIG. 13A), a processor of the terminal 1300 generates a beacon signal having a first period and transmits (e.g., advertises) the same. The processor of the terminal 1300 receives position information of a terminal from a position sensor (not shown), and when the terminal deviates from a specific area (an area between a circle in a solid line and a circle in a dotted line of FIG. 13A), the processor generates a beacon signal having a second period and transmits (e.g., advertises) the same. Here, the second period may be slower than the first period or include a stopping transmission.

As another embodiment, in case where the terminal 1300 exists within a specific area (e.g., a company), the processor transmits a beacon signal in an unencrypted state, and when the terminal 1300 deviates from the specific area, the processor may encrypt the beacon signal and transmit the same. For example, in a case of transmitting a beacon signal related to company business, the processor does not encrypt the beacon signal inside the company, and encrypts the beacon signal and transmits the same outside the company. The above encrypted beacon signal may be deciphered using a code decoding key defined in advance or a key generated for decoding.

Referring to FIG. 13B, a range of a beacon signal may be adjusted depending on a specific position or a specific circumstance. For example, in a case where a beacon signal should be sent far away, the processor may transmit the beacon signal using a relatively strong transmission power of about −20 dBm. In a case where a beacon signal should be sent nearby, the processor may transmit the beacon signal using a relatively weak transmission power of about +10 dBm.

Also, the processor may transmit two different kinds of beacon signals in turns within a specific area. A first beacon signal of the two different kinds does not have nothing to do with a range of a specific area, and a second beacon signal may have something to do with a range of a specific area. At this point, in a case where the terminal 1300 deviates from the specific area, the deviation may not influence an operation of the first beacon signal and may influence only an operation of the second beacon signal. Here, influencing the operation of the second beacon signal may be changing a transmission period, changing contents, changing a reception object, changing transmission power, and changing encryption. Also, a range of the specific area may be defined as Geo-Fence.

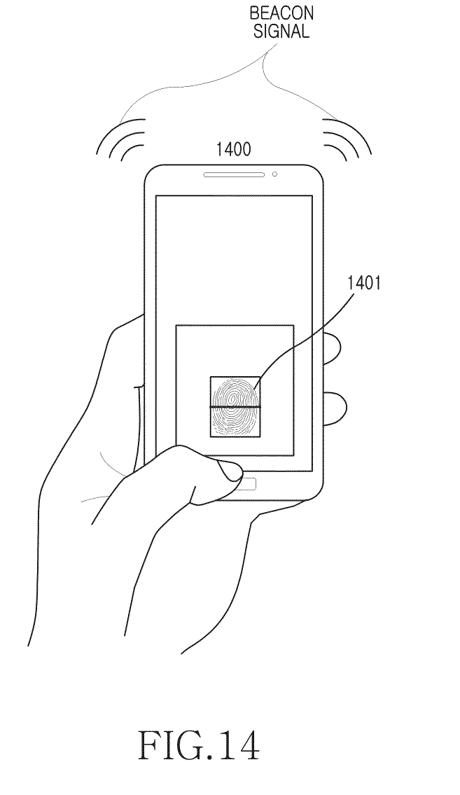

FIG. 14 is a view illustrating an electronic device controlling a beacon signal based on a fingerprint sensor according to an embodiment of the present disclosure.

Referring to FIG. 14, a terminal is illustrated, such that when recognizing a user's fingerprint information 1401 set in advance, a processor of the terminal 1400 may generate a beacon signal related to the fingerprint information 1401 and transmit the same. Here, the beacon signal related to the fingerprint information may be a beacon signal including the fingerprint information, a beacon signal including information authenticated using the fingerprint information, or a beacon signal encrypted using the fingerprint information.

Also, while transmitting a beacon signal including arbitrary contents, when the fingerprint information 1401 is recognized, the processor may encrypt the beacon signal, and designate a reception object such that the beacon signal is transmitted to only a specific counterpart. Here, designating the reception object means incorporating an MAC address, etc. of a reception terminal into a beacon signal and transmitting the same when transmitting the beacon signal, so that the reception terminal may select and receive only a beacon signal that coincides with an MAC address of itself.

Furthermore, the fingerprint information may be utilized in a vehicle or Smart Home. For example, when approaching a vehicle or positioned inside a vehicle, the processor may control the vehicle by transmitting a beacon signal authenticated based on the fingerprint information. Here, controlling the vehicle may be opening the door of the vehicle, adjusting a vehicle internal system, and the vehicle and the terminal cooperate with each other to give and take contents. Also, when approaching home or positioned inside home, the processor may control home by transmitting a beacon signal authenticated based on the fingerprint information. Here, controlling home may be opening the door of home, controlling home appliances inside home, and home and the terminal cooperate with each other to give and take contents.

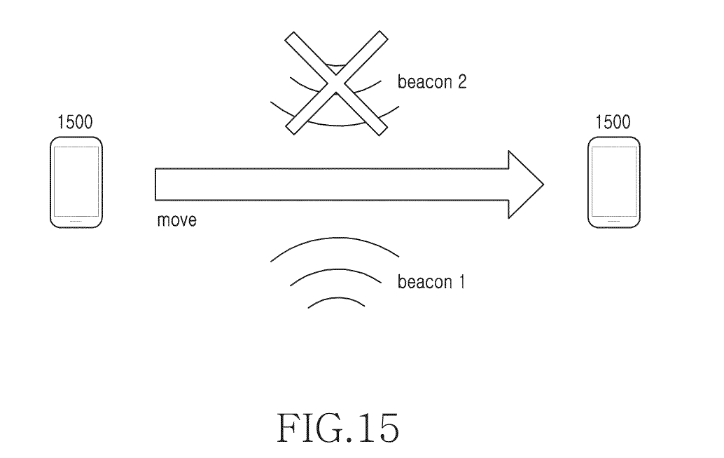

FIG. 15 is a view illustrating an electronic device controlling a beacon signal based on an acceleration sensor according to an embodiment of the present disclosure.

Referring to FIG. 15, a terminal 1500 is illustrated, where a processor of the terminal 1500 may measure that the terminal 1500 moves using an acceleration sensor (not shown). In a case where it is determined that the terminal 1500 moves at a speed equal to or greater than or less than a specific speed, the processor may control a beacon transmission operation of the terminal or control a beacon reception operation.

For example, in a case where the terminal 1500 moves fast at a speed equal to or greater than a specific speed, the terminal 1500 does not receive an unnecessary beacon signal (e.g., beacon 2 of FIG. 15), and selectively receives only a necessary beacon signal (e.g., beacon 1 of FIG. 15). The necessary beacon signal may be a beacon signal including specific content. Specifically, the terminal 1500 may receive a beacon signal including an advertisement and may not receive a beacon signal including contents related to data whose capacity is large.

For another example, the terminal 1500 may receive only a beacon signal transmitted from a specific direction. For example, the terminal 1500 may receive a beacon signal received from the front direction of a movement path and may not receive a beacon signal received from the rear direction of the movement path. For another example of controlling a reception operation of the beacon signal, in a case where the terminal move at a speed equal to or greater than a specific speed, the terminal may change a period of a scan operation for receiving a beacon signal. Here, changing the period of the scan operation may be speeding up, or slowing, or stopping the scan period.

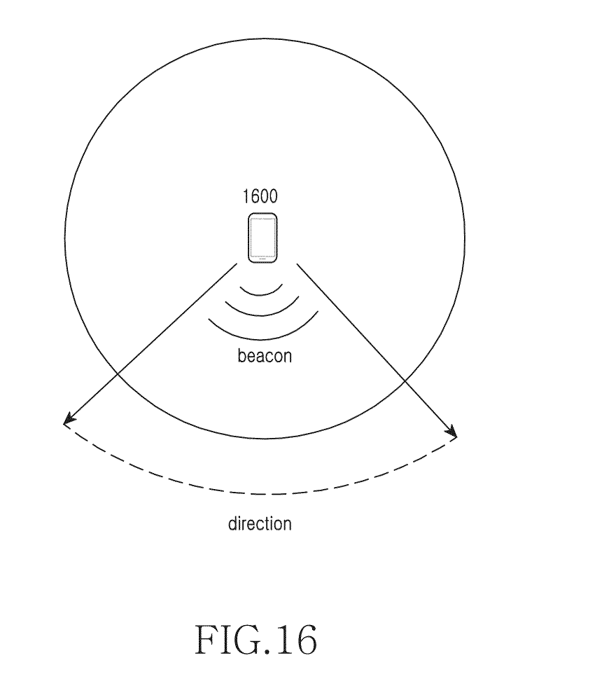

FIG. 16 is a view illustrating an electronic device controlling a beacon signal based on a geomagnetic sensor according to an embodiment of the present disclosure.

Referring to FIG. 16, a terminal 1600 is illustrated, where a processor of the terminal 1600 may measure a direction which the terminal 1600 faces using a geomagnetic sensor (not shown). Therefore, the terminal 1600 may transmit a beacon signal in a direction which the terminal faces or may receive only a beacon signal received from the direction which the terminal faces.

For example, when the terminal 1600 enters an area where stores transmitting various beacon signals are concentrated, or enters a specific store possessing a transmitter transmitting a plurality of beacon signals, the terminal 1600 receives beacon signals from all directions. In this case, since most of a plurality of beacon signals may be unnecessary beacon signals in a position of a user of the terminal, the terminal may selectively receive only a beacon signal received from the direction which the user faces.

One example of a method of determining a beacon signal of the direction which the user faces is to use the user's current position, an absolute coordinate of a position of a point from which a beacon signal is transmitted, and a geomagnetic sensor value of the terminal. Also, a beacon receiver chip itself such as Wi-Fi or Bluetooth may measure directionality for beacon reception.

Also, the processor may recognize the direction which the user faces from an image input to the camera sensor. Furthermore, the processor may control a transmission operation of a beacon signal only in the direction which the user faces by utilizing the geomagnetic sensor. For example, when the user desires to transmit a beacon signal to a specific apparatus, the processor may detect a direction of the specific apparatus which the user faces and control a transmission module so that a beacon signal may be transmitted to only the relevant direction.

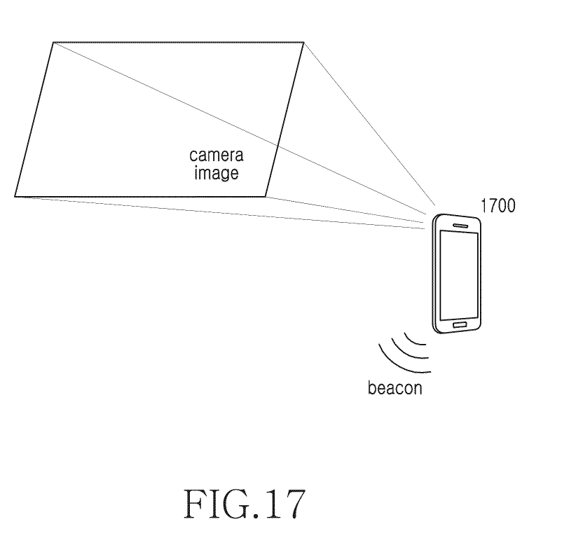

FIG. 17 is a view illustrating an electronic device controlling a beacon signal based on a camera sensor according to an embodiment of the present disclosure.

Referring to FIG. 17, a terminal 1700 is illustrated, such that when use of a camera sensor (not shown) is detected, a processor of the terminal 1700 may generate and transmit a beacon signal related to the camera sensor. The camera sensor may be called a camera or an image sensor, etc.

A beacon signal related to the camera sensor may be, for example, a beacon signal representing that the terminal 1700 is performing camera shooting, or a beacon signal related to an image shot by the camera sensor. That is, the processor may incorporate an image or a moving picture shot by the camera sensor into a beacon signal and transmit the same, or extract information related to an image or a moving picture shot by the camera sensor and then incorporate the relevant information into a beacon signal and transmit the same.

An example of the information related to the image shot by the camera sensor may be a beacon signal where when a user shoots a specific apparatus using the camera sensor, the terminal analyzes information of the specific apparatus included in the image shot by the camera sensor and requests the relevant specific apparatus to connect.

Also, another example of the information related to the image shot by the camera sensor may be summary information regarding the image shot by the camera sensor. For example, when a user shoots a menu board at a restaurant using the camera sensor, the terminal may recognize the menu board in the image shot by the camera sensor, and then incorporate information summarizing the menu board into a beacon signal and transmit the same.

Furthermore, when a user shoots food using the camera sensor, the terminal may analyze food information and incorporate summarized or analyzed information into a beacon signal and transmit the same. At this point, when the image shot by the camera sensor is analyzed, current position information may be used together.

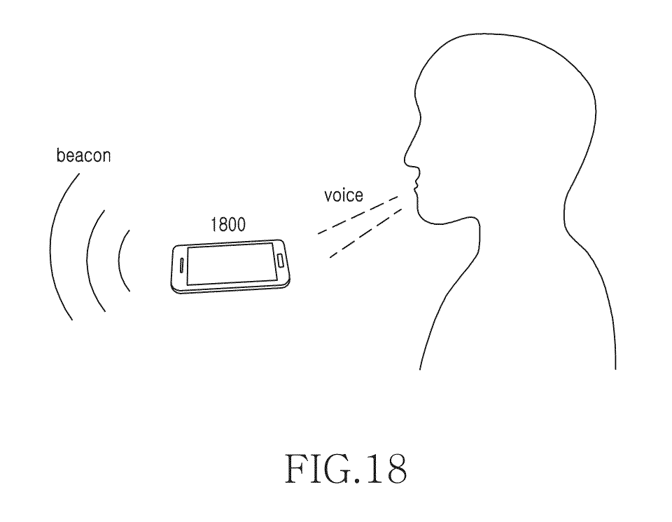

FIG. 18 is a view illustrating an electronic device controlling a beacon signal based on a microphone sensor according to an embodiment of the present disclosure.

Referring to FIG. 18, a terminal 1800 is illustrated, such that when a use of a microphone sensor (not shown) is detected, a processor of the terminal 1800 may generate a beacon signal related to the microphone sensor and transmit the same. The microphone sensor may be called a microphone.

For example, the terminal 1800 may generate a beacon signal representing recording is being performed using the microphone sensor, or a beacon signal may be a beacon signal related to voice input via the microphone sensor. As an example of the beacon signal related to the voice, when a user's voice is input from the microphone sensor, the user is authenticated via voice authentication, so that a beacon signal related to authentication may be generated.

Also, a currently transmitted beacon signal may be encrypted or a security level is changed and then the beacon signal may be transmitted. That is, while unencrypted beacon signal is transmitted, when a user is authenticated by the user's voice input, a security level is changed and a beacon signal may be encrypted as a beacon signal that may be received by only a specific person or a reception object may be designated.

Still another example of a beacon signal related to voice may be communication using a beacon signal. One direction service, etc. such as a push-to-talk may be provided by utilizing a beacon signal. For example, when a user inputs voice via a microphone sensor, the relevant voice may be converted to a digital signal and then incorporated into a beacon signal and transmitted to a counterpart user.

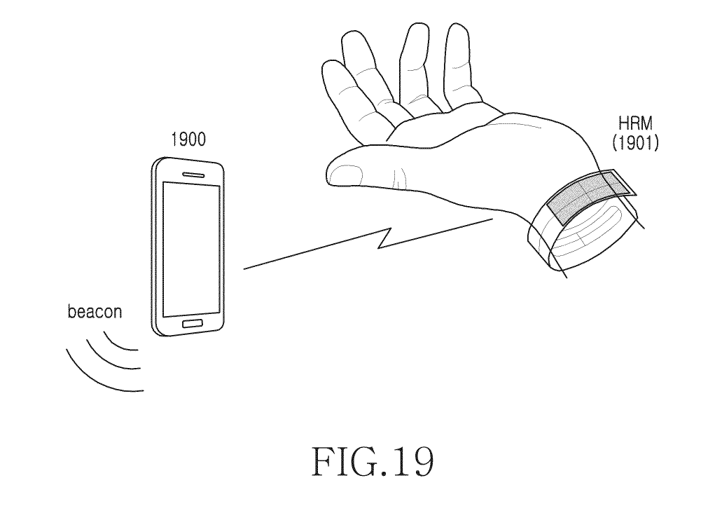

FIG. 19 is a view illustrating an electronic device controlling a beacon signal based on a heart rate measuring unit according to an embodiment of the present disclosure.

Referring to FIG. 19, a terminal 1900 is illustrated, such that when body information of a user is collected from a Heart Rate Monitor (HRM) sensor 1901, a processor of the terminal 1900 may generate a related beacon signal and transmit the same.

For example, when the HRM sensor 1901 is used, checking for a case where a heart rate suddenly becomes very fast although a user does not exercise or a heart rate becomes very slow is possible. In a case where this dangerous situation is detected, the terminal 1900 may generate a beacon signal for this situation and transmit the same to the neighborhood.

Also, the beacon signal may be transmitted to only a designated person, and furthermore, the beacon signal may be transferred to a server (e.g., a server of a police station, etc.) via a data network such as a cellular or Wi-Fi network, etc. The terminal 1900 may generate and transmit a beacon signal using a sensor measuring living body health information such as an oxygen saturation measuring sensor or a stress measuring sensor, etc., similarly with the HRM sensor 1901.

According to various embodiments of the present disclosure, for example, an electronic device such as a smartphone or a tablet PC, etc. dynamically controls a transmission/reception operation of a beacon signal based on various sensor information, thereby automatically controlling a transmission/reception operation of a beacon signal even without a separate user manipulation. Also, an electronic device may efficiently transmit a beacon signal by automatically changing contents, a transmission/reception period, a reception object, encryption, transmission power, etc. of a beacon signal based on various sensor information, and may prevent unnecessary battery power consumption.

Methods according to embodiments described in claims of various embodiment or embodiments described in specification of the present disclosure may be implemented in the form of a hardware, a software, or a combination of a hardware and a software. In a case of implementation using a software, a computer-readable storage medium storing one or more programs (software modules) may be provided. One or more programs stored in the computer-readable storage medium are configured for execution by one or more processors inside an electronic device. One or more programs include instructions allowing an electronic device to execute methods according to embodiments described in claims of various embodiment or embodiments described in specification of the present disclosure.

This program (a software module, a software) may be stored in a non-volatile memory including a RAM, and a flash memory, an EEPROM, a magnetic disc storage device, a Compact Disc (CD)-ROM, a DVD, and/or other types of optical storage devices, and a magnetic cassette. Alternatively, the program may be stored in a memory configured using a combination of a portion or all of these. Also, a plurality of constituent memories may be provided.

Also, the program may be stored in an attachable storage device accessible via a communication network such as the Internet, an Intranet, a Local Area Network (LAN), a Wide LAN (WLAN), or a Storage Area Network (SAN), or a communication network configured using a combination of these. This storage device may access a device that performs an embodiment of the present disclosure via an external port. Also, a separate storage device on a communication network may access a device that performs an embodiment of the present disclosure.

In specific embodiments of various embodiments of the present disclosure, an element included in the disclosure has been expressed in the singular or in the plural depending on a proposed specific embodiment. However, expression of the singular or the plural has been selected so that it is suitable for a suggested circumstance for convenience in description, and various embodiments of the present disclosure are not limited to a singular or plural element. Even an element expressed in the plural may be configured in the singular, or even an element expressed in the singular may be configured in the plural.

Various aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is a case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for operating an electronic device, the method comprising:
receiving sensor information of the electronic device; and
controlling, by the electronic device, a beacon signal based on the sensor information.

2. The method of claim 1, wherein the sensor information is detected by at least one of a motion sensor, a position sensor, a fingerprint sensor, an acceleration sensor, a geomagnetic sensor, a camera sensor, a microphone sensor, and a heart rate monitor sensor.

3. The method of claim 1, wherein the controlling comprises generating a beacon signal corresponding to a correlation between currently received sensor information and a beacon signal that is currently being transmitted or received, or that is transmitted or received within a reference time set in advance.

4. The method of claim 1, wherein the beacon signal is transmitted by at least one of a baseband module, a Wi-Fi module, a Bluetooth module, an infrared module, and a speaker.

5. The method of claim 1, wherein the controlling comprises changing at least one of contents of the beacon signal, a transmission/reception period of the beacon signal, a reception object of the beacon signal, an encryption of the beacon signal, and a transmission power of the beacon signal based on the sensor information.

6. The method of claim 5, wherein the contents of the beacon signal comprise at least one of a Uniform Resource Locator (URL), a text, an image, and a moving picture.

7. The method of claim 5, wherein the transmission/reception period of the beacon signal comprises a frequency by which the beacon signal is transmitted/received at a specific time.

8. The method of claim 5, wherein the reception object of the beacon signal is a phone book, an address list inside a terminal, and user information or terminal information registered in a social network service.

9. The method of claim 5, wherein the beacon signal is selectively encrypted when the electronic device deviates from a specific area.

10. The method of claim 5, wherein the transmission power of the beacon signal reduces when the electronic device deviates from a specific area or is repeatedly replaced with different transmission powers inside the specific area.

11. The method of claim 1, wherein the controlling of the beacon signal adjusts a transmission power of the beacon signal based on a location of the electronic device with respect to a specific location.

12. An electronic device comprising:
a sensor module configured to detect sensor information; and
a processor configured to control a beacon signal based on the sensor information detected by the sensor module.

13. The electronic device of claim 12, wherein the sensor module comprises at least one of a motion sensor, a position sensor, a fingerprint sensor, an acceleration sensor, a geomagnetic sensor, a camera sensor, a microphone sensor, and a heart rate monitor sensor.

14. The electronic device of claim 12, wherein the processor is further configured to generate a beacon signal corresponding to a correlation between currently received sensor information and a beacon signal that is currently being transmitted or received, or that is transmitted or received within a reference time set in advance.

15. The electronic device of claim 12, wherein the beacon signal is transmitted via at least one of a baseband module, a Wi-Fi module, a Bluetooth module, an infrared module, and a speaker.

16. The electronic device of claim 12, wherein the processor is further configured to change at least one of contents of the beacon signal, a transmission/reception period of the beacon signal, a reception object of the beacon signal, an encryption of the beacon signal, and a transmission power of the beacon signal based on the sensor information.

17. The electronic device of claim 16, wherein the contents of the beacon signal comprise at least one of an advertisement, a Uniform Resource Locator (URL), a text, an image, and a moving picture.

18. The electronic device of claim 16, wherein the transmission/reception period of the beacon signal comprises a frequency by which the beacon signal is transmitted/received at a specific time.

19. The electronic device of claim 16, wherein the reception object of the beacon signal is a phone book, an address list inside a terminal, and user information or terminal information registered in a social network service.

20. The electronic device of claim 16, wherein the beacon signal is selectively encrypted when the electronic device deviates from a specific area, and the transmission power of the beacon signal reduces when the electronic device deviates from a specific area or is repeatedly replaced with different transmission powers inside the specific area.

21. A non-transitory computer-readable storage medium storing instructions that, when executed, cause at least one processor to perform the method of claim 1.
